(19) United States
(12) Patent Application Publication
(10) Pub. No.: US 2013/0120204 A1
(43) Pub. Date: May 16, 2013

(54) MICROWAVE SCANNER

(71) Applicants: Thomas Schoeberl, Hildesheim (DE); Thomas Focke, Ahrbergen (DE); Reinhard Meschenmoser, Hannover (DE); Arne Zender, Bad Salzdetfurth (DE); Thomas Hansen, Hildesheim (DE); Joerg Hilsebecher, Hildesheim (DE); Karl Nesemann, Lohfelden (DE); Oliver Lange, Hannover (DE)

(72) Inventors: Thomas Schoeberl, Hildesheim (DE); Thomas Focke, Ahrbergen (DE); Reinhard Meschenmoser, Hannover (DE); Arne Zender, Bad Salzdetfurth (DE); Thomas Hansen, Hildesheim (DE); Joerg Hilsebecher, Hildesheim (DE); Karl Nesemann, Lohfelden (DE); Oliver Lange, Hannover (DE)

(21) Appl. No.: 13/636,634

(22) PCT Filed: Jan. 28, 2011
(86) PCT No.: PCT/EP2011/051186

§ 371 Date: Jan. 30, 2013

(30) Foreign Application Priority Data
Mar. 26, 2010 (DE) 10 2010 003 327.8

(51) Int. Cl. H01Q 13/00

(52) U.S. Cl. CPC H01Q 13/00
USPC 343/772

(57) ABSTRACT

A transmitting device for electromagnetic radiation includes a waveguide having an input for coupling an electromagnetic wave into the waveguide, and multiple openings in the waveguide for emitting the electromagnetic wave. A controllable closure element is provided for selectively closing at least one of the openings with respect to the electromagnetic radiation.

### BACKGROUND OF THE INVENTION

1. Field of the Invention

The present invention related to a microwave scanner.

2. Description of the Related Art

For microwave systems as used, for example, in radar devices for motor vehicles, one measuring method is to guide a focused microwave beam over a visual range and to scan a surrounding area with the aid of the microwave radiation. This requires an antenna which emits into a narrowly defined space. In addition, the spatial direction of the emission must be changed to allow the visual range to be scanned. Antennas or antenna systems which meet this requirement are referred to as scanners.

To avoid mechanical movement of the antenna, use may be made of the fact that in waveguides, the wavelength of the electromagnetic propagation is a function of the frequency. When a suitable waveguide is used, different electromagnetic waves which originate from the same electromagnetic radiation source may be superimposed in such a way that the radiation direction of the superimposed waves is a function of the frequency. Such an antenna is referred to as a frequency scanner (frequency scanning array).

Published German patent application document DE 10 2007 045 013 A1 discloses a radar device for scanning a long range with the aid of a continuous modulated radar signal, or alternatively, scanning a short range with the aid of a pulsed modulated radar signal.

Published German patent application document DE 37 38 705 A1 discloses a system for changing the radiation characteristic of a microwave antenna with the aid of a lens system.

### BRIEF SUMMARY OF THE INVENTION

The object of the present invention is to provide a transmitting device with the aid of which different radiation characteristics may be easily achieved.

According to the present invention, a transmitting device for electromagnetic radiation includes a waveguide having an input for feeding an electromagnetic wave, the waveguide having multiple openings for the electromagnetic wave to exit from the waveguide. A controllable closure element is provided for selectively closing at least one of the openings with respect to the electromagnetic wave.

The radiation characteristic of the transmitting device may be influenced in a targeted manner by selectively opening or closing one or multiple openings of the waveguide. In particular, as a function of a control of the closure element, at least two radiation characteristics may be achieved which differ in their extensions, for example their opening angles and/or ranges. A microwave system may thus be easily built which scans different spatial areas depending on the control of the closure element.

A first radiation characteristic is preferably narrower, with a larger antenna gain, than a second radiation characteristic. Scanning in a long range may be carried out in a narrow visual range with the aid of the first radiation characteristic, while in a short range, scanning may be carried out in a broader visual range with the aid of the second radiation characteristic.

The openings may be situated in the waveguide in such a way that a radiation direction of the electromagnetic radiation is a function of the frequency of the radiation. A scanner may thus be easily built in which the relatively frequent change in the radiation direction is carried out via the frequency, without changing mechanical components, while the much less frequent switching between a short range and a long range is carried out with the aid of the closure element.

The closure element may be set up to only partially close at least one of the openings. As a result of the partial closing, the radiation of the electromagnetic wave at the affected opening may be reduced, the reduction being a function of the degree of closing. In this way, the radiation characteristic may be advantageously controlled in a particularly accurate manner.

The closure element may be set up to uniformly close multiple openings. The closure element may include a mechanical slider which may be twisted or moved, for example, in a direction perpendicular to the direction of propagation of the electromagnetic radiation. By providing appropriate perforations in the slider, multiple configurations of open and closed openings may be easily achieved, so that a plurality of different radiation characteristics may be provided at different positions of the slider.

The openings may be arranged in a row. As a result, the exiting electromagnetic radiation is not influenced in a direction perpendicular to the direction of extension of the row, regardless of the frequency of the electromagnetic radiation and the control of the closure element. This specific embodiment is particularly advantageous for a typical scanner having a constant elevation angle. The openings may be uniformly spaced apart, thus making it possible to advantageously achieve or improve a symmetry of the radiation characteristic with regard to the radiation direction.

The electromagnetic radiation may be radar radiation.

### BRIEF DESCRIPTION OF THE DRAWINGS

FIG. 1 shows a transmitting device for electromagnetic radiation.

FIG. 2 shows different radiation characteristics of the transmitting device from FIG. 1.

FIG. 3 shows the transmitting device from FIG. 1 with selectively closed openings.

### DETAILED DESCRIPTION OF THE DRAWINGS

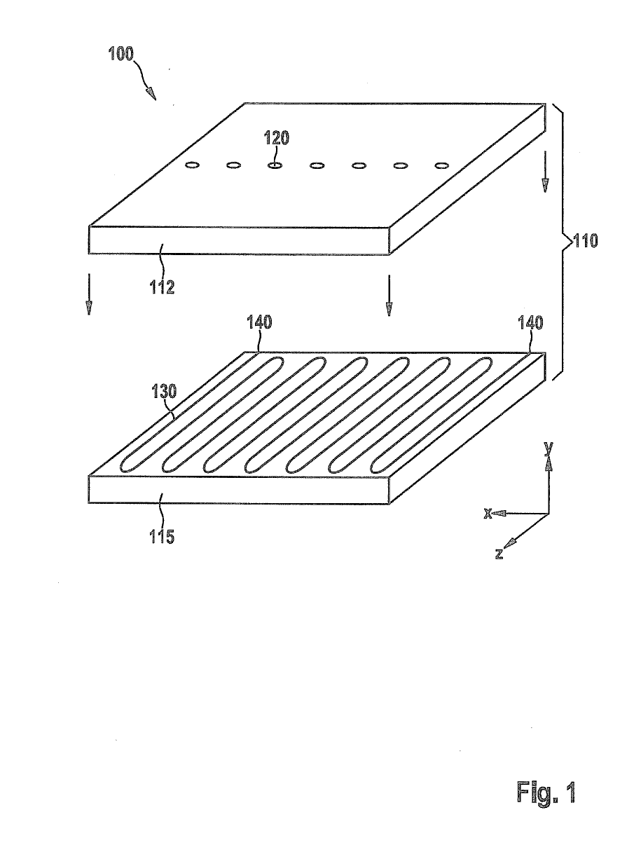

FIG. 1 shows an exploded illustration of a transmitting device 100 for electromagnetic radiation. Transmitting device 100 includes a waveguide 110 having a top part 112 and a bottom part 115. During operation, parts 112 and 115 are situated one on top of the other, as indicated by the vertical arrows. Mutually corresponding indentations in the two parts 112, 115 form a meander 130 which ends at inputs 140 at the edge of waveguide 110. In principle, one input 130 is sufficient; second illustrated input 130 is optional. A row of openings 120 is introduced into top part 112 in the vertical direction, each of openings 120 meeting meander 130 at a different location.

As shown, transmitting device 100 may be composed, for example, of two plates 112, 115 made of brass or another metal, for example, or may also be formed in some other way so that an appropriate waveguide results.

With the aid of a junction (not shown), an electromagnetic wave may be coupled into meander 130 via one or both of inputs 130. The electromagnetic wave propagates along meander 130 and partially exits upwardly through openings 120. Each beam of microwave radiation exiting from openings 120 has a characteristic distance from the input used, which influences the phase position of the exiting microwave radiation. The shape, size, and configuration of openings 120 are preferably selected in such a way that each of openings 120 may be modeled as a punctiform source of electromagnetic radiation. Openings 120 may be filled with a material which is permeable to the electromagnetic radiation in order to prevent foreign bodies from entering into waveguide 110.

Meander 130 is formed between openings 120 in such a way that the microwave radiation beams exiting through openings 120 are superimposed above transmitting device 100 corresponding to their phase positions, resulting overall in a radiation characteristic and a radiation direction of the electromagnetic radiation due to positive and negative interference.

Electromagnetic high frequency is preferably periodically irradiated into transmitting device 100 with frequency modulation, thus forming a radiation characteristic which is a function of the frequency due to the interfering radiation exiting from openings 120. It is particularly preferred that openings 120 are matched to meander 130 and to the frequency-modulated radiation in such a way that the radiation characteristic of transmitting device 100 assumes a frequency-controlled direction with respect to the z axis. The direction periodically changes due to the periodically controlled high frequency, so that electromagnetic radiation is emitted in a visual range of transmitting device 100. Reflections of this radiation may pass over the same route in the opposite direction and be received by a junction at one of inputs 130], so that a conclusion may be drawn concerning objects in the visual range by comparing the transmitted high frequency to the received high frequency.

To achieve different radiation characteristics of transmitting device 100, some of openings 120 have a closable design with respect to the microwave radiation emitted into meander 130. This may be achieved using a microwave-impermeable diaphragm, which may be provided in front of one or more of openings 120. The diaphragm may open or close one or more of openings 120, depending on the position, so that the microwave radiation exiting from openings 120 is a function of the position of the diaphragm. The diaphragm may be movable, rotatable, or foldable with respect to openings 120, and may be made of a metal plate, for example. Differently sized openings in the diaphragm, which may be completely or partially aligned with openings 120, are able to completely or partially open each of openings 120. The diaphragm may be designed in such a way that multiple different positions allow multiple predefined patterns of opened openings 120 which correspond to multiple predefined radiation characteristics of transmitting device 100.

In another specific embodiment, instead of a mechanical closure a closure is provided which is directly controllable with the aid of an electrical or optical signal. For example, a semiconductor may be situated in front of one of openings 120 and brought into various conductivities with the aid of a control voltage, so that, as a function of its conductance, the semiconductor releases microwave radiation from opening 120. An individually controllable closure element may be situated in front of each of the openings, so that different radiation characteristics may result without having to carry out a mechanical movement at transmitting device 100. In another specific embodiment, the control of the conductance, and thus of the permittivity with respect to microwave radiation, may be synchronized with the frequency modulation of the electromagnetic wave irradiated into input 140 in order to achieve a bundling of the resulting radiation characteristic which is a function of the orientation of the emitted radiation.

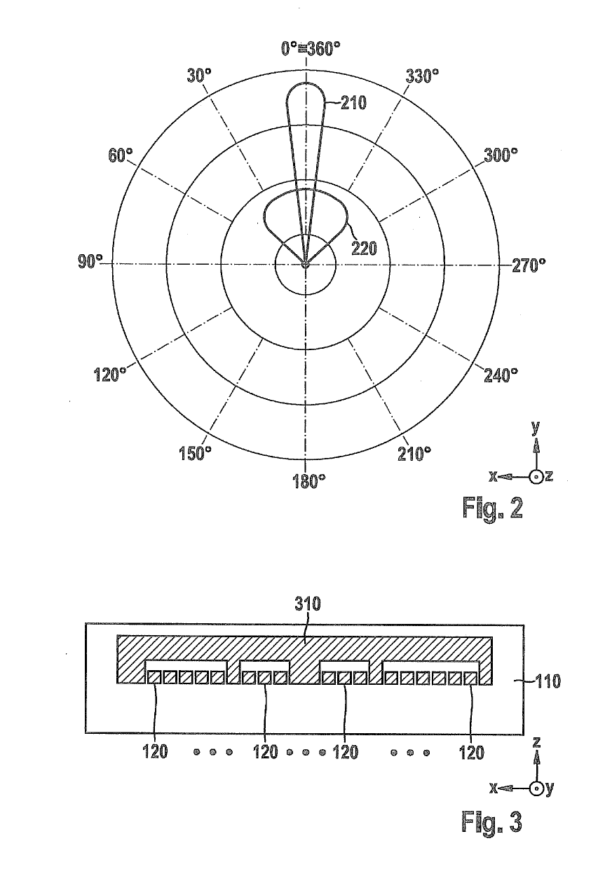

FIG. 2 shows different radiation characteristics of transmitting device 100 from FIG. 1. A first radiation characteristic 210 and a second radiation characteristic 220 are plotted into a polar coordinate system. An additionally indicated Cartesian coordinate system simplifies the reference to the illustration in FIG. 1.

Transmitting device 100 is not explicitly illustrated, and is located at the origin of the polar coordinate system. The 0° direction corresponds to the y direction in FIG. 1, and the 90° direction corresponds to the x direction in FIG. 1. For both radiation characteristics 210 and 220, a point on the contour line is defined by a direction in the polar coordinate system and by a distance from the origin of the polar coordinate system, the distance of the point corresponding to a signal strength. Thus, the preferred radiation direction and an associated spatial distribution of the radiation are readable from each of the plotted radiation characteristics 210, 220. In a typical application, for example in a scanner radar of a motor vehicle, the illustration in FIG. 2 corresponds to a top view.

Both radiation characteristics 210 and 220 are essentially symmetrical with respect to the 0° direction. The maximum opening angle of illustrated first radiation direction 210 is approximately 12°, while the maximum opening angle of second radiation characteristic 220 is approximately 60°. The highest signal strength of first radiation characteristic 210 in the 0° direction is almost twice the highest signal strength of second radiation characteristic 220 in the same direction.

Thus, first radiation characteristic 210 is particularly suited for scanning a remote target, for example with the aid of long range radar (LRR). Second radiation characteristic 220 is better suited for short range scanning, for example with the aid of medium range radar (MRR) or short range radar (SRR).

A change in the radiation direction due to a change in the frequency of the electromagnetic radiation, as described above with reference to FIG. 1, may be represented in the provided polar illustration by rotating particular radiation characteristic 210, 220 about the origin of the polar coordinate system. The ideally illustrated lobe shape of radiation characteristics 210 and 220 is usually distorted during such a change in direction. However, the basic properties of radiation characteristics 210 and 220 with regard to opening angle and signal strength are maintained.

FIG. 3 shows transmitting device 100 from FIG. 1 with selectively closed openings 120. Openings 120 are shown as an example, and do not correspond to openings 120 shown in FIG. 1. The perspective corresponds to a viewing direction in

FIG. 1 from below and along the y axis, i.e., in the direction in which microwave radiation exits from openings 120.

Of openings 120 in waveguide 110, some are closed with the aid of a diaphragm 310. With reference to a numbering system in the positive x direction of openings 120 from left to right in FIG. 3, openings 1, 2, 8, 12, 13, 17, 24, and 25 are closed by diaphragm 310. For example, second radiation characteristic 220 in FIG. 2 is thus achieved. If diaphragm 310 is moved upwardly (in the positive z direction) so that none of openings 120 are closed, another radiation characteristic, for example first radiation characteristic 210 from FIG. 2, results.

The illustrated configuration and shape of openings 120 in waveguide 110 are examples. In other specific embodiments, openings 120 may have a shape that is not rectangular, and may be separated from one another by different distances. Openings 120 may also be distributed in two dimensions (x and z) on the inner surface of waveguide 110 illustrated in FIG. 1, instead of being arranged in a row as illustrated. For example, openings 120 may be arranged along a circle or an ellipse. Multiple circles or ellipses may be concentric with one another.

Diaphragm 310 is designed corresponding to openings 120. In other specific embodiments, diaphragm 310 may also be set up to be moved along the x axis in addition to or instead of a motion along the z axis. Furthermore, diaphragm 310 may also be rotated about the y axis. This is particularly advantageous for an arrangement of openings 120 along circles or ellipses, as described above. Diaphragm 310 may be designed to bring about multiple patterns of closed, partially closed, or open passages 120.

In other specific embodiments, multiple diaphragms 310 may also be used, and in particular each hole 120 to be closed may have an individual slider 120. In one variant, diaphragm 310 may be replaced by a flap mechanism. In yet another specific embodiment, openings 120 to be closed may also be selectively closable with respect to electromagnetic radiation with the aid of another controllable closure element, for example an element whose electromagnetic permeability is voltage-controlled.

The present invention is particularly suited for building a microwave scanner for use in a motor vehicle radar, in a motion detector or in a burglar alarm system, and other applications in which scanning antennas in the microwave range are desired.

1-11. (canceled)

12. A transmitting device for electromagnetic radiation, comprising:
a waveguide having an input for feeding an electromagnetic wave into the waveguide;
a first opening in the waveguide for the electromagnetic wave to exit as radiation;
at least one additional opening in the waveguide; and
a controllable closure element configured to selectively close, at least partially, at least one of the openings in the waveguide with respect to the electromagnetic wave.

13. The transmitting device as recited in claim 12, wherein at least two radiation characteristics which differ in their extensions are achieved as a function of the control of the closure element.

14. The transmitting device as recited in claim 13, wherein a first radiation characteristic is narrower than a second radiation characteristic.

15. The transmitting device as recited in claim 13, wherein the openings are situated in the waveguide in such a way that a radiation direction of the electromagnetic radiation is a function of the frequency of the electromagnetic wave.

16. The transmitting device as recited in claim 13, wherein the closure element is configured to only partially close at least one of the openings.

17. The transmitting device as recited in claim 13, wherein the closure element is configured to uniformly close the openings in the waveguide.

18. The transmitting device as recited in claim 13, wherein the closure element includes a mechanical slider.

19. The transmitting device as recited in claim 13, wherein the closure element includes a material whose conductivity is one of electrically or optically controllable.

20. The transmitting device as recited in claim 15, wherein the openings are arranged in a row.

21. The transmitting device as recited in claim 15, wherein the openings are uniformly spaced apart.

22. The transmitting device as recited in claim 19, wherein the electromagnetic radiation is radar radiation.
